(19) United States
(12) Patent Application Publication
(10) Pub. No.: US 2009/0192793 A1
(43) Pub. Date: Jul. 30, 2009

(54) METHOD FOR INSTANTANEOUS PEAK LEVEL MANAGEMENT AND SPEECH CLARITY ENHANCEMENT

(76) Inventors: Desmond Arthur Smith, Randburg Gauteng (ZA); H. Christopher Schweitzer, Lafayette, CO (US)

Correspondence Address: POLSINELLI SHUGHART PC, 700 West 47th Street, Suite 1000, KANSAS CITY, MO, 64112, US

(21) Appl. No.: 12/361,508

(22) Filed: Jan. 28, 2009

Related U.S. Application Data
(60) Provisional application No. 61/024,858, filed on Jan. 30, 2008.

(51) Int. Cl. G10L 21/02

(52) U.S. Cl. 704/225

(57) ABSTRACT

A method for raising the soft and mid-level amplitude of sounds for greater clarity and perceptual benefit, while simultaneously removing the high level amplitude peaks without delay and providing protection for the auditory sense organ. The method does not require a feedback mechanism for the accomplishment of this treatment and exploits the psychoacoustic phenomenon of temporal integration which reduces the audibility of short duration signals, including distortions associated with peak clipping. The human auditory system requires greater time to integrate signal energy for audibility than provided by brief duration waveform peaks.

### PRIORITY TO RELATED APPLICATIONS

This application claims the benefit of U.S. Provisional Application No. 61/024858 filed Jan. 30, 2008, which is incorporated herein by reference in its entirety as if fully set forth herein.

### FIELD OF THE INVENTION

The present invention relates to audio signal processing generally. More particularly, the present invention is related to an improved system and method for instantaneous audio signal peak dynamic adjustment for improving the audibility of consonants while simultaneously preserving the sound quality of vowels, and for eliminating potentially damaging acoustic impulse transients to benefit hearing preservation.

### BACKGROUND OF THE INVENTION

The science and art of Signal Processing, in some cases enabled by digital control methods, has enabled the development of a wide range of signal alteration methods, including steep and flexible filtering, dynamic range compression, pitch transformations and various noise reduction schemes. Particularly in the area of dynamic range compression of signal amplitude, most prior art approaches require a feedback loop in which some detection threshold and voltage control mechanism is used to reduce outputs in excess of a defined output level. These approaches, by necessity, introduce some time constant or time delay for the adjustments to take place, usually tens of milliseconds in duration. Perceptual disturbances often result from such delay times. Furthermore, brief transient peaks may pass through during the adaptive process, which may potentially damage the inner ear hair cells. Impulse noise damage is often more likely to occur than auditory damage resulting from longer duration noises, largely due to the fact that the integration time required for loudness experience in the human auditory system is on the order of 100 to 200 milliseconds. Stated differently, physically damaging intensity levels may not be perceived or experienced by a listener psycho-acoustically in such a way as to encourage listener withdrawal.

Signal processing designs intended to reduce excessively high peak intensities and/or control dynamic levels are disclosed in U.S. Pat. No. 4,249,042 issued to Orban, which requires frequency band separation and the use of a gain control feedback loop. Although that method uses a clipping technique for overshoot protection, it will be shown that the present invention has important and innovative differences over the '042 disclosure with regard to the use of clipping.

U.S. Pat. Nos. 4,208,548 and 5,168,526 also issued to Orban more specifically propose methods for controlling clipping in analog voltage amplification systems but also employ by high frequency filter methods to remove undesired distortion. It should be noted that high frequency filtering does not remove low frequency inter-modulation distortion components in complex signals. The present invention has several distinguishable properties of detection, and does not require filter techniques to remove perceptual distortions.

U.S. Pat. No. 5,815,532 issued to Bhattacharya, et al. discloses a method for processing radio broadcast signals in which carrier frequencies can be subdivided with control sidebands. More recently, lshimitsu, et al. in U.S. Pat. No. 5,255,325 describe yet another method of automatic gain control with a time constant table for adjusting the delays resulting from the feedback loop. Similarly, U.S. Pat. No. 6,757,396 issued to Allred clearly introduces delays related to the feedback loop design. On the other hand, U.S. Pat. No. 7,233,200 issued to Yamada discloses methodology which makes estimates for the appropriate recovery time constant based on detection of the signal level of the input signal in units of a period of the input signal. However, the method disclosed by Yamada is intended for recording purposes and is not appropriate for real time applications. Notably, the system and method of the present invention is suitable for both recorded and live audio processing.

The processing method of the present invention overcomes these and other problems not solved by the prior art by abandoning the commonly used feedback loop and providing an innovative method of controlled peak clipping and signal detection. This method introduces precisely calculated amplification of soft and medium sounds to the benefit of auditory detail perception and especially, speech understanding. It simultaneously reduces on an instantaneous basis, short duration high level impulse spikes. This effectively attenuates stress on the crucial hair cilia of the cochlea, thus providing a valuable hearing conservation benefit to the listener. The combination of high level outputs and extended listening time for entertainment, telecommunication, and other electronic audio devices, is well understood to cause permanent sensori-neural hearing impairment. By reducing exposures to many thousands of impulse peaks that occur over the course of even just a few hours of audio signal transmissions, a clear protective and prophylactic benefit is expected from the present invention's system and method of manipulating the processed audio signal.

### BRIEF DESCRIPTION OF THE DRAWINGS

FIG. 1 is a flow diagram of the processing stages, of the present invention;

FIG. 2 is a graphic representation of the acoustic pattern of an example of a recorded passage of music illustrating that the average energy distribution lies at 10 dB below the peak energy values (32% of peak);

FIG. 3 is an enlarged view of the acoustic pattern FIG. 2 illustrating that the contribution to total power by excursions over 10 dB is less than half the power contributed by remaining signals;

FIG. 4 is illustrates a post peak-excision of 10 dB of the peak power from the waveform of FIG. 2;

FIG. 5 illustrates the signal of FIGS. 2-4 amplified after clipping (or ‘overdriven’ by 10 dB);

FIG. 6 illustrates the classical temporal integration pattern for human listeners showing the steep fall off of detection ability as a function of duration; Loudness does not fully integrate until signal duration reaches approximately 100 milliseconds;

FIG. 7 illustrates the averaged spectrum of a single sentence speech sample without the processing of the present invention. The low frequencies are naturally greater in intensity, which makes perception of the higher frequency consonants more difficult;

FIG. 8 illustrates the speech sentence shown in FIG. 7 following processing by the present invention showing that the averaged spectrum is flattened without the undesired consequence of biasing the frequency response by filtering the low frequency region;

FIG. 9.a illustrates the acoustic waveform of a female speaker's utterance of the word, “Intuition”;

FIG. 9.b illustrates the wave form of FIG. 9.a following processing by the present invention showing that soft consonants have been intensified rendering an audible clarity improvement;

FIG. 10.a illustrates the acoustic waveform of a male speaker's utterance of a sentence simultaneously over-laid with a series of sharp, high intensity impulse. After processing by the present invention (FIG. 10.b) the impulses spikes are clearly removed. Simultaneously, soft speech has been intensified to the advantage of greater clarity.

FIG. 10.b illustrates the waveform of FIG. 10.a following processing by the present invention showing the removal of the impulse spikes accompanied by soft speech intensification and audible sound clarity improvement.

### DESCRIPTION OF THE INVENTION

It should be noted that the present description is by way of instructional examples and the concepts presented herein are not limited to use or application with any single audio processing device. Hence, while the details of the processing innovation described herein are for the convenience of illustration and explanation, with respect to exemplary embodiments, the principles disclosed may be applied to other types and applications of audio electronic signal transmission. They can be implemented in both digital and analog constructions. If in analog, the skillful selection of RC time constants can be used to enable the unique detection and treatment stages of the invention described in the next paragraph; whereas, in digital form, it is a matter of programming the appropriate parameters.

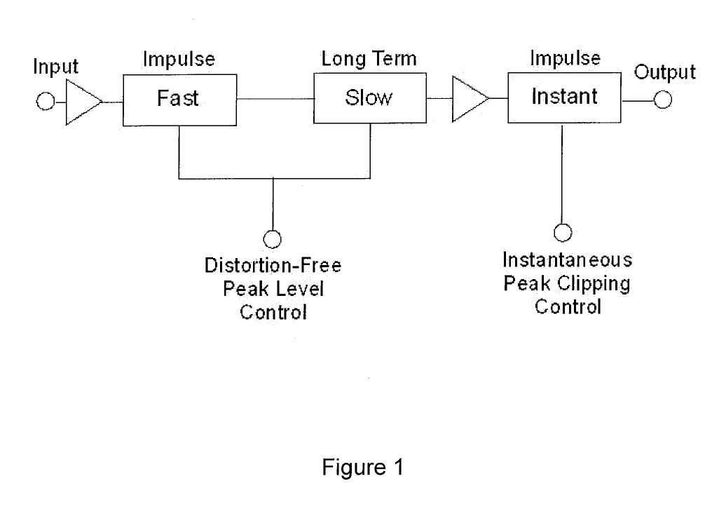

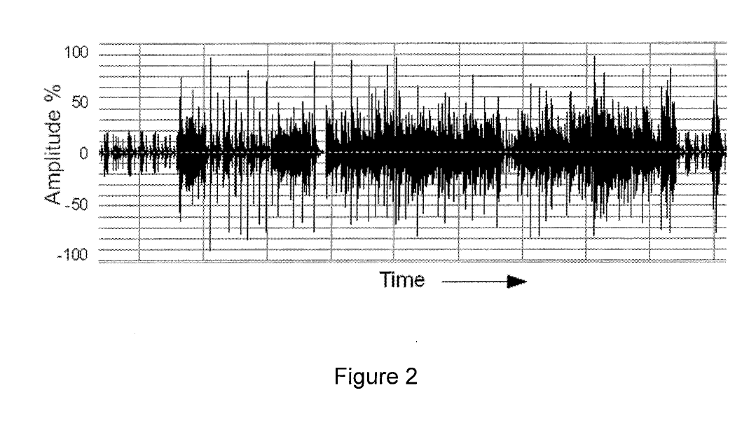

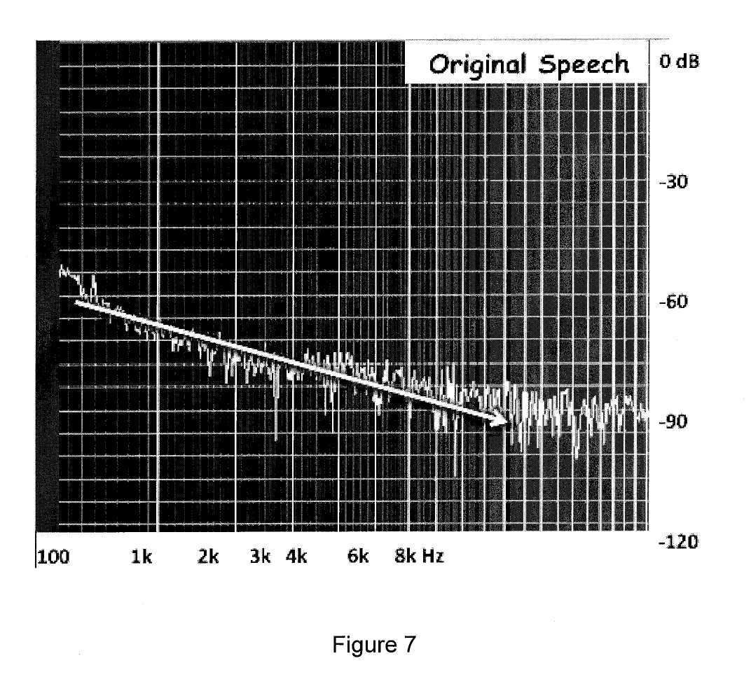

Referring now to FIG. 1, dynamically changing signals, such as those of a recorded music passage as shown in FIG. 2 or a human speech pattern as shown in FIG. 7, are examined and treated within three separate time analysis windows depending upon the rate of amplitude change. A distortion free fast detector applies a 2 millisecond (msec.) attack and release to brief impulses or generally quick changes in amplitude; by way of example, amplitude changes that occur in the range of approximately 2 msec. to approximately 2 seconds. A rapid decrease in amplitude triggers the fast release element. Hence, both the attack and the release are dependent upon the rate of input amplitude change.

Slower changing signal amplitudes, such as rhythmic vocal patterns, are managed by a 2000 msec. (2 second) attack and release time. This time period covers several spoken words and enables the general level of the voice to be identified. Essentially this component of the method maintains a continuous surveillance on the incoming level of a speech signal in order to best maintain clarity and naturalness in the signal's output and reduces the speed of the clipping step when the rate of input signal amplitude change is greater than approximately 2 seconds.

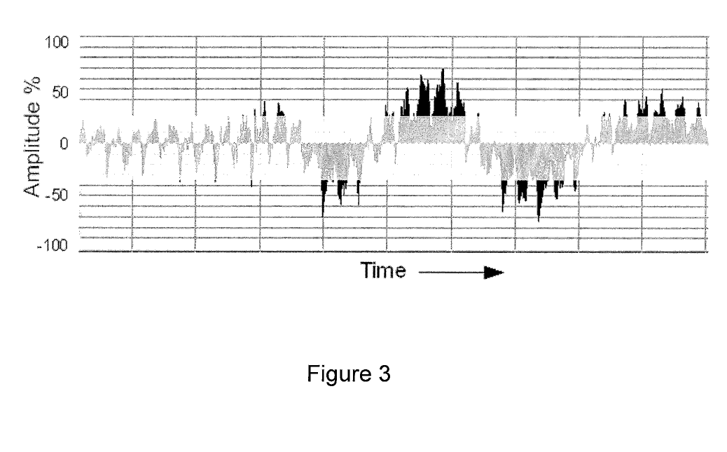

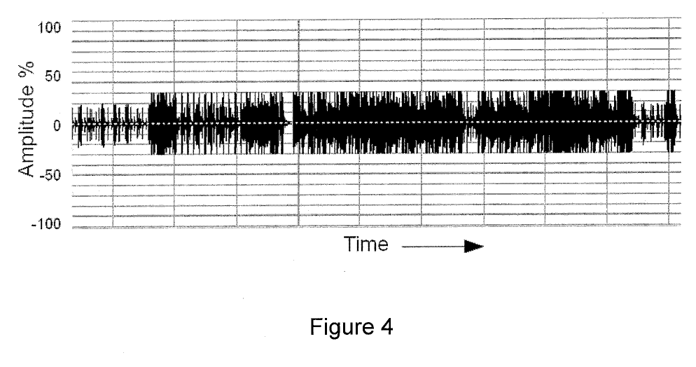

The present invention exploits the psychoacoustic property of temporal integration in the human auditory system. This is a crucial aspect of the method. It is known that loudness of signals is integrated within a time window of approximately 100 milliseconds. Hence, shorter duration impulse spikes sound considerably softer and are often imperceptible. An illustration of this is shown in FIGS. 3 and 4. In that example, a particular dynamic amplitude pattern of a music passage is illustrated, by way of example, with 10 dB reduction of the amplitude peaks removed by the present invention with a net consequential loudness reduction of only 0.2 dB due to the psycho-acoustically determined temporal integration. Since the total period in which the brief transients occur is only about 10 msec. or 1/10^{th} of the 100 msec. loudness integration window, the peak levels will contribute no more than 1/20^{th} of the total power in the 100 msec. auditory integration window. This will result in a loudness increase of 10(log(1+ 1/20)) or only 0.2 dB. Hence, it can be seen that the instantaneous limiting of peak power does not significantly affect loudness; however, the potentially damaging spikes have been removed. Prior art assumptions on the audibility of clipping induced distortions are predicated on conventional measurement methods which greatly elongate and often ‘freeze’ for visual analysis signals that are factually very brief. This common incorrect portrayal of the perceptual consequences of brief signal distortions, such as harmonics resulting from clipping, directly relates to the unique features of the present method.

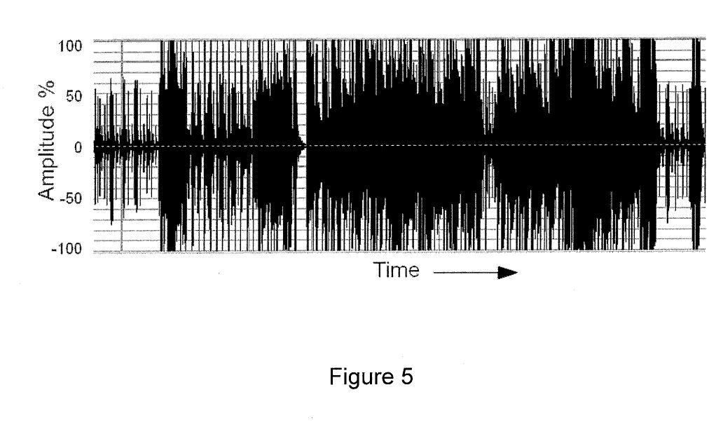

Referring now to FIG. 5, the audio signal of FIGS. 3 and 4 is shown amplified after clipping or “overdriven” by 10 dB. The average levels of long duration signals are increased, which results in increased loudness for soft and midlevel sounds, the net effect of which is to enhance the detail and clarity of the signal.

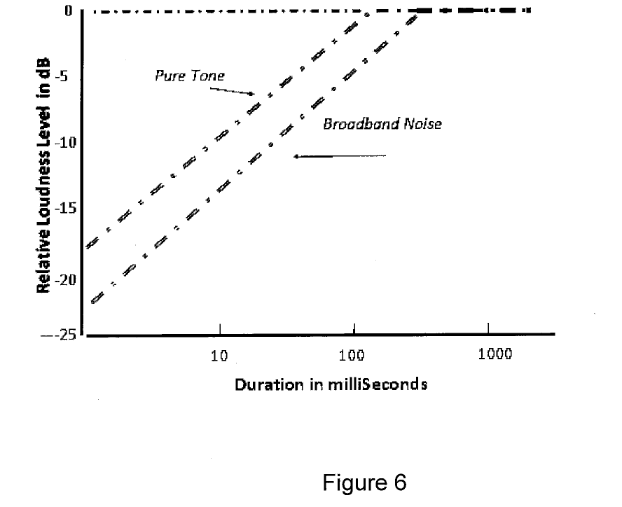

High level impulses that are extremely fast, i.e., less than 2 msec., are instantaneously adjusted downward by the third stage shown in FIG. 1 which applies controlled clipping with no time delay. The extreme brevity of these signals renders the distortion associated with the clipping to generally imperceptible levels due to the temporal integration roll off illustrated in FIG. 6 and as explained previously.

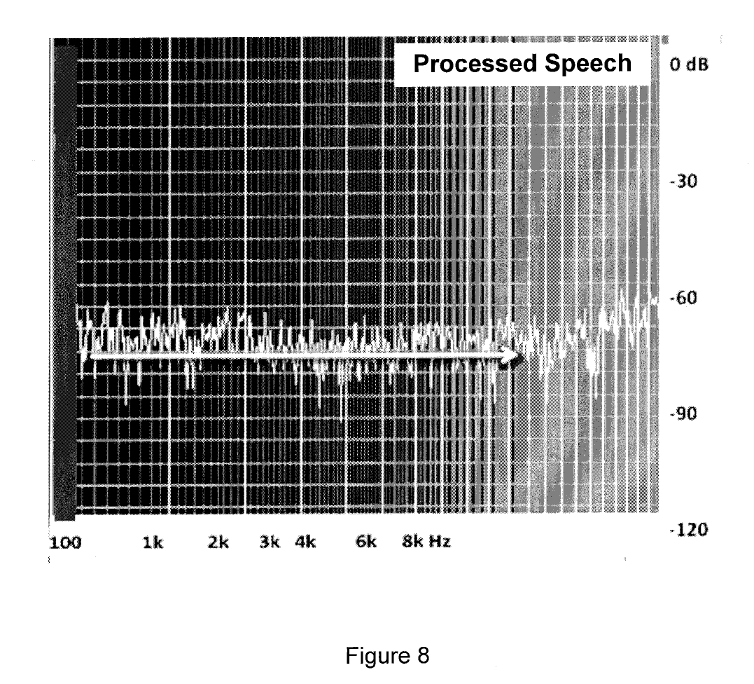

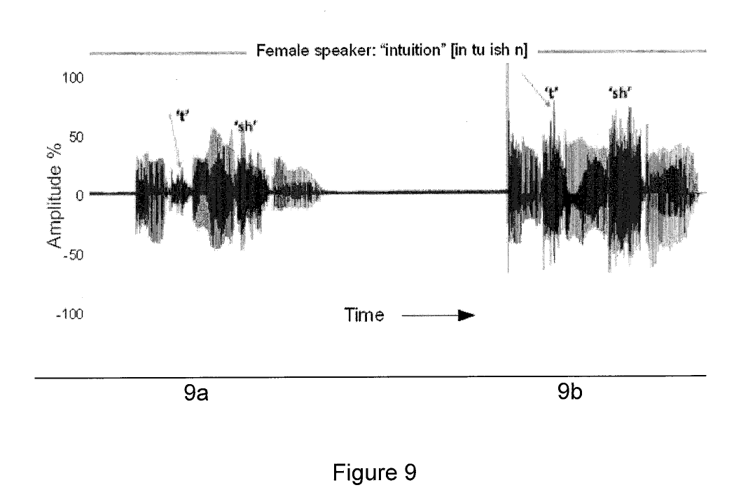

Speech clarity in audio systems and especially noisy input environments is often compromised by the greater intensity of low frequency, higher energy vowels which tend to mask the higher frequency, lower intensity consonants. Traditional approaches often apply filter techniques to attenuate the low frequency noise and voice components. In some cases the approach is to bias the spectrum in favor of the high frequencies. Both have the effect of creating an undesirable tinny sound and a negative perceptual effect on voice quality. The present invention avoids this problem by boosting all soft and mid level sounds without filtering or frequency biasing. The range of the applied gain value is between approximately 1 dB and 40 dB. As soft speech sounds pass through the system, a flattening of the spectrum is accomplished, leaving the vowels and vocal properties undisturbed, but a clear increase in the intensity and perceptibility of the softer, voiceless consonants. This is illustrated quite clearly in FIGS. 7 and 8. Additionally, FIG. 9 shows the sequential waveforms of a female speaker uttering the multi-syllabic word “intuition.” It is clear that the soft consonants, such as the “T” and “SH” are intensified in the processed sample using the present invention. It is important to note that the processing did not alter the basic vocal properties while instantaneously producing clarity enhancements.

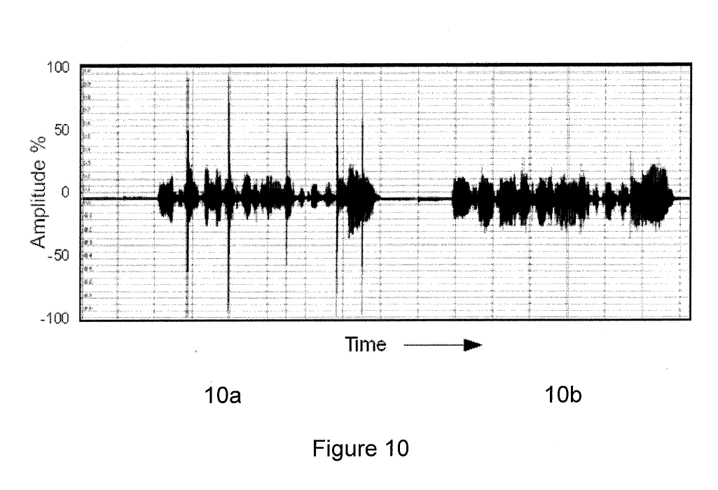

Sudden sharp transient acoustical spikes are both annoying and potentially damaging to the delicate hair cell structures of the inner ear. The present invention instantaneously removes such impulses (FIG. 10) without delay or added distortion typically associated with existing approaches.

A train of pulses impulses (or peaks in a continuous sinusoidal or complex signal) is treated as a Long Term signal. Because the attack and release is an exponential function the recovery on termination of a vowel in speech is relatively fast—which permits almost full amplification of consonants or other low level sounds, e.g., in music.

Changes may be made in the above methods, devices and structures without departing from the scope hereof. It should thus be noted that the matter contained in the above description and/or shown in the accompanying drawings should be interpreted as illustrative and not in a limiting sense. The following claims are intended to cover all generic and specific features described herein, as well as all statements of the scope of the present method, device and structure, which, as a matter of language, might be said to fall there between.

What is claimed is:

1. A method for improving the clarity of acoustic speech signals, comprising:
continuously measuring the average level of an input signal;
applying at least one gain value to the speech signal by a predetermined factor; and
simultaneously clipping the peak values of the input speech signal by a precalculated amount, whereby the soft high frequency unvoiced spoken components are perceptuallly enhanced.

2. The method of claim 1 further including continuously measuring the input signal wave form amplitude and the rate of wave form amplitude change.

3. The method of claim 2 including adjusting the speed of the clipping step in response to the measured rate of wave form amplitude change.

4. The method of claim 3 wherein the clipping step is performed instantaneously when the rate of wave form amplitude change is less than 2.0 milliseconds.

5. The method of claim 3 wherein the speed of the clipping step is reduced when the rate of wave form amplitude change is greater than 2.0 milliseconds.

6. The method of claim 5 wherein the speed of the clipping step is further reduced when the rate of wave form amplitude change is greater than 2.0 seconds.

7. The method of claim 1 wherein the range of applied gain value is between approximately 1 dB and approximately 40 dB.

8. The method of claim 1 wherein the input signal comprises a broadband signal.

9. The method of claim 1 wherein the input signal comprises multiple frequency band segmented signals.
